(19) United States
(12) Patent Application Publication
(10) Pub. No.: US 2019/0168048 A1
(43) Pub. Date: Jun. 6, 2019

(54) JET FUEL FIRE SIMULATOR

(71) Applicant: Carrier Corporation, Jupiter, FL (US)

(72) Inventors: Robert L. Fillmore, Bloomington, MN (US); Michael John Hosch, Fridley, MN (US)

(21) Appl. No.: 16/324,833

(22) PCT Filed: Aug. 18, 2017
(86) PCT No.: PCT/US2017/047581

§ 371 Date: Feb. 11, 2019

Related U.S. Application Data
(60) Provisional application No. 62/377,933, filed on Aug. 22, 2016.

(51) Int. Cl. A62C 99/00

(52) U.S. Cl. CPC A62C 99/0081

(57) ABSTRACT

A simulator for performing live fire testing includes a containment pan, a fuel distribution assembly positioned within the containment pan, a fuel source arranged in fluid communication with the fuel distribution assembly, and a diffusion means substantially covering the fuel distribution assembly. Attributes of a fire generated using the simulator are substantially similar to attributes of a jet-fuel fire.

### BACKGROUND

Embodiments of this disclosure relate generally to a system for detecting predefined conditions within a building and, more particularly, to a radiant energy flame detecting system.

The detectors of an optical flame detection system, such as used in an aircraft hangar, are typically tested after being installed to ensure that the detectors are properly oriented to detect a fire. This testing commonly includes igniting a fire using jet fuel and positioning the fire at different locations throughout the hangar to confirm operation of each detector. It is undesirable to use jet fuel to perform these tests because jet fuel is difficult to ignite, is difficult to control the ignition temperature thereof, and once lit is difficult to extinguish. In addition, special arrangements must be made for the collection and disposal of the jet fuel, and jet fuel fires generate a heavy dark smoke that leaves a greasy residue and strong smell within the hangar after the tests are completed.

It is therefore desirable to perform such live fire tests using a different type of fuel. However, to determine that the optical detectors are operational for their intended purpose, the live fire used for testing must have substantially similar characteristics, for example flicker, magnitude, phase relationship and wavelength to a fire using jet fuel.

### SUMMARY

According to a first embodiment, a simulator for performing live fire testing includes a containment pan, a fuel distribution assembly positioned within the containment pan, a fuel source arranged in fluid communication with the fuel distribution assembly, and a diffusion means substantially covering the fuel distribution assembly. Attributes of a fire generated using the simulator are substantially similar to attributes of a jet-fuel fire.

In addition to one or more of the features described above, or as an alternative, in further embodiments the attributes include flicker, magnitude, phase relationship, and wavelength.

In addition to one or more of the features described above, or as an alternative, in further embodiments the containment pan includes a generally planar base and at least one sidewall extending from the base to define a cavity.

In addition to one or more of the features described above, or as an alternative, in further embodiments the fuel distribution assembly is removably mounted within the cavity.

In addition to one or more of the features described above, or as an alternative, in further embodiments the fuel source is a gaseous fuel.

In addition to one or more of the features described above, or as an alternative, in further embodiments the fuel source is one of liquid petroleum, propane, butane, and ethylene.

In addition to one or more of the features described above, or as an alternative, in further embodiments the fuel distribution assembly is configured to evenly distribute fuel from the fuel source within the containment pan.

In addition to one or more of the features described above, or as an alternative, in further embodiments the fuel distribution assembly includes a plurality of sections of pipe arranged in fluid communication. Each of the plurality of sections of pipe includes a plurality of holes through which fuel from the fuel source is expelled.

In addition to one or more of the features described above, or as an alternative, in further embodiments comprising a ball valve arranged within a fluid flow path defined between the fuel distribution assembly and the fuel source. The ball valve is movable between an open position and a closed position to selectively couple the fuel source to the fuel distribution assembly.

In addition to one or more of the features described above, or as an alternative, in further embodiments a pressure regulator and an in-line flow meter are arranged within a fluid flow path defined between the fuel distribution assembly and the fuel source. The pressure regulator is operable to adjust a flow rate of fuel from the fuel source to the fuel distribution assembly as measured by the in-line flow meter.

In addition to one or more of the features described above, or as an alternative, in further embodiments the diffusion mechanism is configured to reduce a velocity of fuel as it is expelled from the fuel distribution assembly.

In addition to one or more of the features described above, or as an alternative, in further embodiments the simulator is mountable to a movable support for movement between a plurality of positions during operation of the simulator.

According to another embodiment, a simulator for performing live fire testing includes a containment pan, a fuel distribution assembly positioned within the containment pan, and a fuel source arranged in fluid communication with the fuel distribution assembly. The fuel provided from the fuel source to the fuel distribution assembly is output from the fuel distribution assembly with a substantially zero velocity.

In addition to one or more of the features described above, or as an alternative, in further embodiments a diffusion mechanism substantially covers the fuel distribution assembly.

In addition to one or more of the features described above, or as an alternative, in further embodiments the diffusion mechanism minimizes the velocity of the fuel as it is output from the fuel distribution assembly.

In addition to one or more of the features described above, or as an alternative, in further embodiments the diffusion mechanism comprises a generally porous material.

In addition to one or more of the features described above, or as an alternative, in further embodiments the diffusion mechanism comprises a plurality of chain arranged in overlapping arrangement with the fuel distribution assembly.

In addition to one or more of the features described above, or as an alternative, in further embodiments the diffusion mechanism comprises a plurality of stones arranged in overlapping arrangement with the fuel distribution assembly.

In addition to one or more of the features described above, or as an alternative, in further embodiments the fuel is a not a jet fuel and attributes of a fire generated using the simulator are substantially similar to attributes of a jet-fuel fire.

### BRIEF DESCRIPTION OF THE DRAWINGS

The subject matter, which is regarded as the present disclosure, is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a perspective view of a fire simulator according to an embodiment;

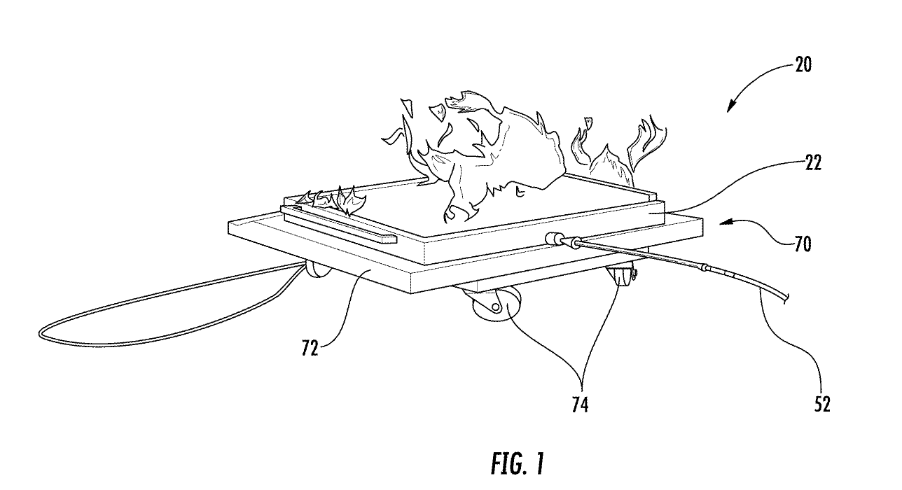

FIG. 2 is a perspective view of a fuel distribution assembly of the fire simulator according to an embodiment;

FIG. 3 is a perspective view of a diffusion mechanism of the fire simulate according to an embodiment;

FIG. 3A is a perspective view of another diffusion mechanism of the fire simulator according to an embodiment;

FIG. 4 is a schematic diagram of the fire simulator according to an embodiment; and

FIG. 5 is a perspective view of a movable support for use with the fire simulator according to an embodiment.

The detailed description explains embodiments of the present disclosure, together with advantages and features, by way of example with reference to the drawings.

### DETAILED DESCRIPTION

Referring now to the FIGS. a simulator 20 for producing a live fire having substantially identical characteristics to a jet fuel fire is illustrated. The simulator 20 includes a metal containment pan 22 within which the fire is located. The containment pan 22 includes a generally planar base 24 and has one or more sidewalls 26 extending therefrom. In an embodiment, the sidewalls 26 extend generally perpendicular to the base 24, such as in a vertically upward direction for example, to define a cavity 28 between the base 24 and the sidewalls 26. As shown, the containment pan 22 is generally rectangular in shape; however other shapes are also contemplated herein. In the illustrated, non-limiting embodiment, the base 24 has a width of about 2′ and a length of about 2′ and the sidewalls 26 extend vertically about 3″. The sizes of the containment pan 22 described herein are intended as an example only, and it should be understood that other sizes are also within the scope of the disclosure.

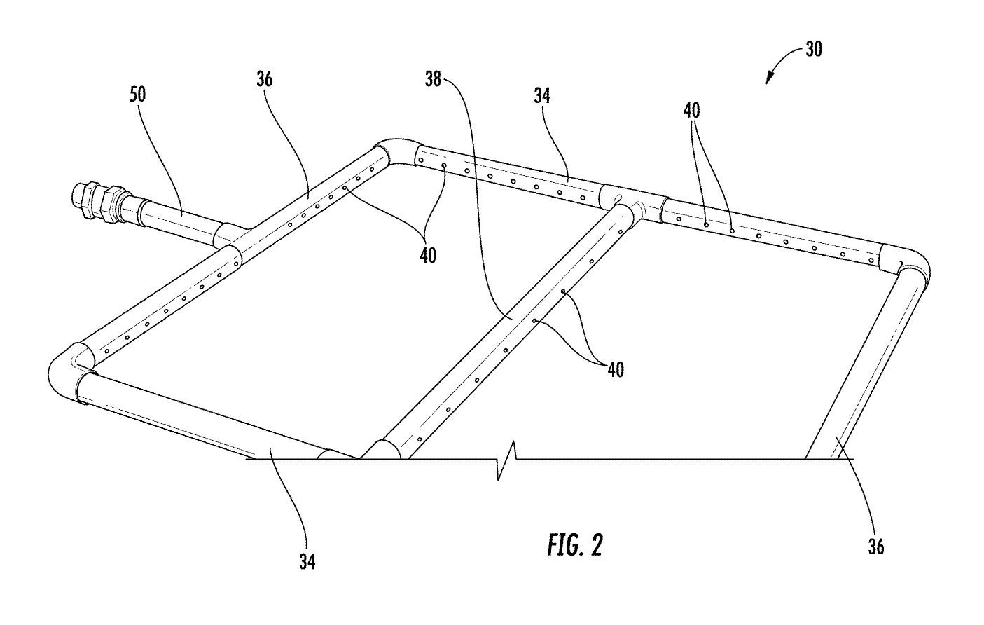

A fuel distribution assembly 30 is receivable within the cavity 28 of the containment pan 22. In some embodiments, the fuel distribution assembly 30 is removably coupled, such as with one or more fasteners (not shown) for example, to the base 24 and/or sidewalls 26 of the containment pan 22. The fuel distribution assembly 30 may be generally complementary in at least one of size and shape to the cavity 28. For example, as shown in FIG. 2, the fuel distribution assembly 30 is generally rectangular in shape and is dimensioned to be only slightly smaller than the containment pan 22, to easily fit therein. However, embodiments where the size and shape of the fuel distribution assembly 30 are substantially distinct from the size and shape of the cavity 28 are also contemplated herein.

The fuel distribution assembly 30 comprises a plurality of sections of pipe 32 arranged in fluid communication. The configuration of the plurality of sections of pipe 32 is intended to evenly distribute an ignitable fuel source across the cavity 28 of the containment pan 22. In the illustrated, non-limiting embodiment, the fuel distribution assembly 30 includes a plurality of sections of copper pipe 32 that have been soldered together to form a rectangle having two pairs of opposing sides 34, 36. In addition, a cross-piece 38 arranged generally at the center of the fuel distribution assembly 30 extends between a pair of opposing sides 34.

Each of the sections of pipe 32 has a plurality of small holes 40 formed therein. The holes 40 may, but need not be, substantially identical and are generally formed in rows in a portion of the pipe sections 32 facing inwardly towards an interior of the cavity 28. The configuration including the size and positioning of the holes 40 is generally selected to evenly distribute fuel across the fuel distribution assembly 30. In an embodiment, the holes 40 have a diameter of about 0.193 inches and are equidistantly spaced over each of section of pipe 32. In embodiments where the fuel distribution assembly 30 includes at least one cross-piece 38, the at least one cross piece 38 includes two rows of holes 40 arranged on opposing sides thereof to evenly distribute the fuel on both sides of the cross-piece 38.

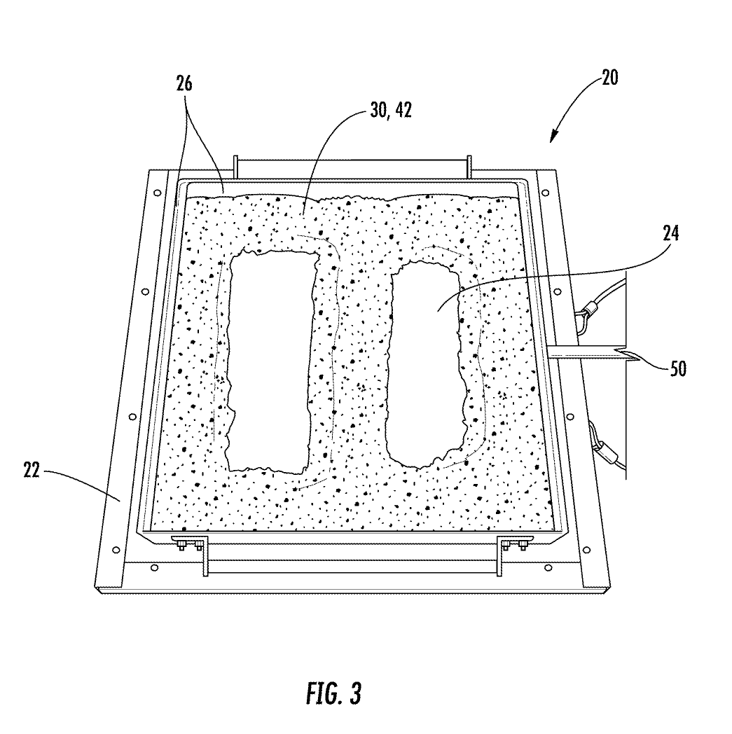

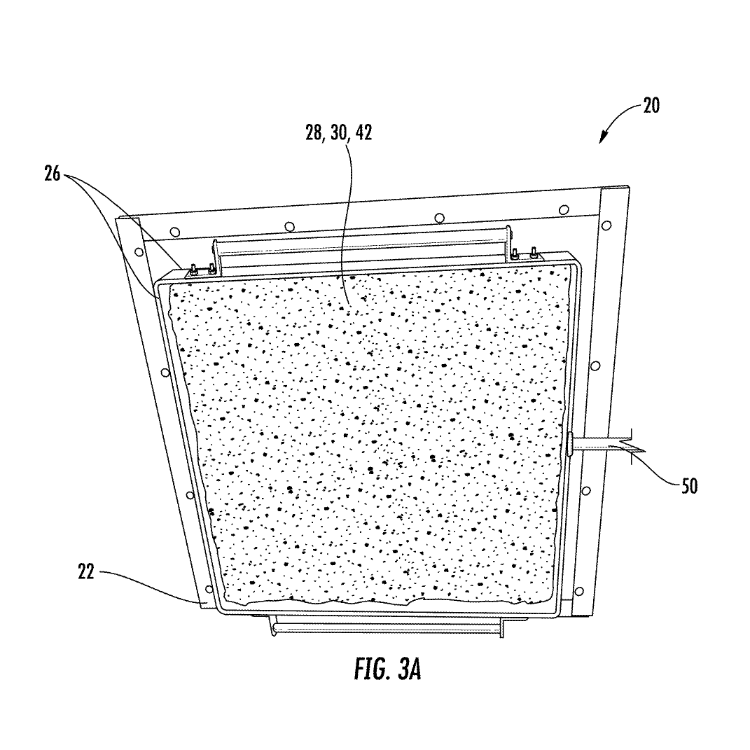

To create a fire having attributes, such as flicker characteristics, magnitude, phase relationship, and wavelength for example, that closely resemble those of ignited jet fuel, the fuel should be provided to the cavity 28 for ignition at or near zero velocity. The velocity of the fuel may be slowed as it is provided to the cavity 28 via the holes 40 in the fuel distribution assembly 30 by positioning a diffusion mechanism 42 in overlapping arrangement with the fuel distribution assembly 30. With reference now to FIGS. 3 and 3A, the diffusion mechanism 42 is a porous material through which the fuel must pass before being ignited. The diffusion mechanism 42 adjusts the frequency component of the fire generated to mimic the flicker characteristics of a jet fuel fire. In the illustrated, non-limiting embodiments, the diffusion mechanism 42 includes one or more pieces of chain, such as approximately 2500 feet of stainless steel #18 jack chain for example. The diffusion mechanism 42 may be layered over the plurality of sections of pipe 32 of the fuel distribution assembly 30 such that the fuel distribution assembly 30 is substantially covered as shown in FIG. 3 or may substantially cover the entire cavity 28 including the fuel distribution assembly 30, as shown in FIG. 3A. Although not all diffusion mechanisms 42 may be suitable for use in every application of the simulator 20, other diffusion mechanisms considered within the scope of the disclosure include, but are not limited to pea gravel, lava rocks, and fire glass for example.

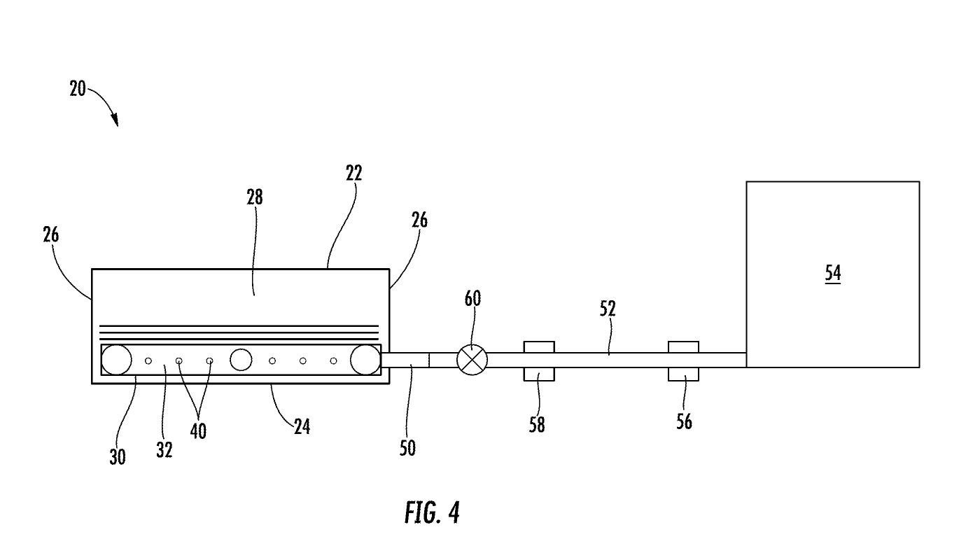

With reference now to FIG. 4, an inlet 50 of the fuel distribution assembly 30 of the simulator 20 is operably coupled via a hose 52 to an ignitable fuel source 54 other than jet fuel. The fuel source 54 comprises a clean-burning and easily controlled type of gaseous fuel. Examples of suitable fuel types include, but are not limited, to liquefied petroleum, butane, propane, and ethylene for example. Positioned along the fluid flow path extending between the fuel distribution assembly 30 and the fuel source 54 is a high pressure regulator 56, an inline flow monitor 58, and a ball valve 60. The ball valve 60 may be movable, for example rotatable, between an open position and a closed position to selectively couple the fuel source 54 to the fuel distribution assembly 30. In embodiments where the ball valve 60 is in an open position, and therefore an unrestricted flow is provided from the fuel source 54 to the fuel distribution assembly 30, the pressure regulator 56 may be adjusted to produce a desired fuel flow rate as measured by the in-line flow monitor 58.

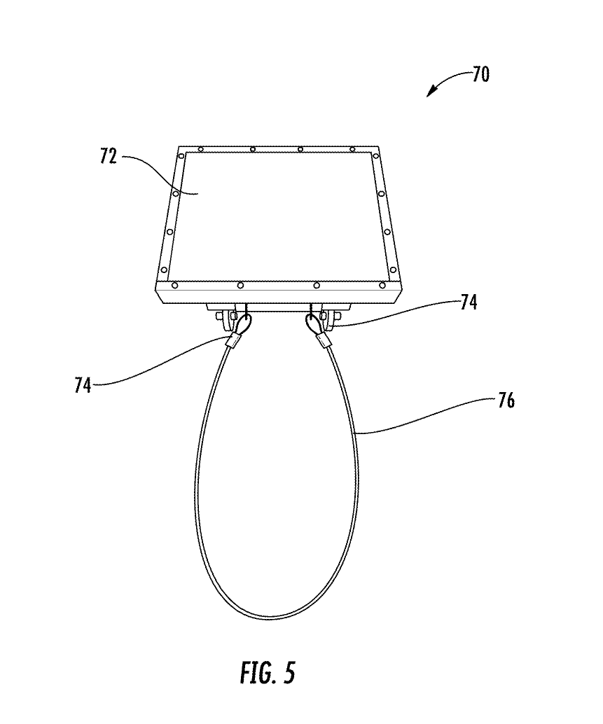

In an embodiment, the simulator 20 may be positioned on top of a movable support 70, to allow a user to easily transport the simulator 20 between multiple locations. An example of the movable support 70 is illustrated in FIG. 5. The support 70 includes a platform 72 formed from a fire resistant material, such as cement board for example, on which the containment pan 22 of the simulator 20 may be located. Mounted to the platform 72 are multiple wheels or casters 74 that allow the platform 72 to easily traverse across a surface or floor. A connector 76, such as a chain or handle for example, may extend from a portion of the support 70 such that a force may be applied to the connector 76 to cause the movable support 70 to move in the direction of the applied force. The movable support 70 is configured such that when the simulator 20 is positioned thereon, the movable support 70 is easy to move, even with the added weight of the simulator 20. In addition, the movable support 70 is designed to prevent the operational simulator 20 from damaging the floor located directly adjacent thereto.

The configuration of the simulator 20 illustrated and described herein was tuned until the spectral and temporal nature of the radiant fire energy produced was substantially equivalent to that of a jet fuel fire. As monitored by a detector, such as the Det-Tronics X3301 flame detector, the characteristics, specifically the flicker, magnitude, phase, and cross-power of both the fire generated by the simulator and a jet fuel fire are substantially similar. However, the flame generated by the simulator 20 may be adapted for use with other types of detectors.

The simulator 20 provides a safe, repeatable, and effective means for generating an easily controlled and easily extinguished fire that may be evaluated at multiple test locations inside and outside a hangar or other building. The simulator produces a reduced amount of smoke and residue when compared to conventional jet fuel fires.

While the disclosure has been described in detail in connection with only a limited number of embodiments, it should be readily understood that the invention is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the invention is not to be seen as limited by the foregoing description, but is only limited by the scope of the appended claims.

1. A simulator for performing live fire testing comprising:
a containment pan;
a fuel distribution assembly positioned within the containment pan;
a fuel source arranged in fluid communication with the fuel distribution assembly;
and
a diffusion means substantially covering the fuel distribution assembly, wherein attributes of a fire generated using the simulator are substantially similar to attributes of a jet-fuel fire.

2. The simulator according to claim 1, wherein the attributes include flicker, magnitude, phase relationship, and wavelength.

3. The simulator according to claim 1, wherein the containment pan includes a generally planar base and at least one sidewall extending from the base to define a cavity.

4. The simulator according to claim 3, wherein the fuel distribution assembly is removably mounted within the cavity.

5. The simulator according to claim 1, wherein the fuel source is a gaseous fuel.

6. The simulator according to claim 5, wherein the fuel source is not jet fuel.

7. The simulator according to claim 5, wherein the fuel source is one of liquid petroleum, propane, butane, and ethylene.

8. The simulator according to claim 1, wherein the fuel distribution assembly is configured to evenly distribute fuel from the fuel source within the containment pan.

9. The simulator according to claim 7, wherein the fuel distribution assembly includes a plurality of sections of pipe arranged in fluid communication, and each of the plurality of sections of pipe includes a plurality of holes through which fuel from the fuel source is expelled.

10. The simulator according to claim 1, further comprising a ball valve arranged within a fluid flow path defined between the fuel distribution assembly and the fuel source, the ball valve being movable between an open position and a closed position to selectively couple the fuel source to the fuel distribution assembly.

11. The simulator according to claim 1, wherein a pressure regulator and an in-line flow meter arranged within a fluid flow path defined between the fuel distribution assembly and the fuel source, the pressure regulator being operable to adjust a flow rate of fuel from the fuel source to the fuel distribution assembly as measured by the in-line flow meter.

12. The simulator according to claim 1, wherein the diffusion mechanism is configured to reduce a velocity of fuel as it is expelled from the fuel distribution assembly.

13. The simulator according to claim 1, wherein the simulator is mountable to a movable support for movement between a plurality of positions during operation of the simulator.

14. A simulator for performing live fire testing comprising:
a containment pan;
a fuel distribution assembly positioned within the containment pan;
a fuel source arranged in fluid communication with the fuel distribution assembly wherein a fuel provided from the fuel source to the fuel distribution assembly is output from the fuel distribution assembly with a substantially zero velocity.

15. The simulator according to claim 13, wherein a diffusion mechanism substantially covers the fuel distribution assembly.

16. The simulator according to claim 14, the diffusion mechanism minimizes the velocity of the fuel as it is output from the fuel distribution assembly.

17. The simulator according to claim 14, wherein the diffusion mechanism comprises a generally porous material.

18. The simulator according to claim 16, wherein the diffusion mechanism comprises a plurality of chain arranged in overlapping arrangement with the fuel distribution assembly.

19. The simulator according to claim 16, wherein the diffusion mechanism comprises a plurality of stones arranged in overlapping arrangement with the fuel distribution assembly.

20. The simulator according to claim 13, wherein the fuel is a not a jet fuel and attributes of a fire generated using the simulator are substantially similar to attributes of a jet-fuel fire.

21. The simulator according to claim 19, wherein the attributes include flicker, magnitude, phase relationship, and wavelength.
